(19) United States
(12) Patent Application Publication
(10) Pub. No.: US 2018/0016049 A1
(43) Pub. Date: Jan. 18, 2018

(54) SYSTEM AND METHOD FOR REMOVING NET WRAP MATERIAL

(71) Applicants: Austin Anthony Schmitz, Axtell, KS (US); Peter Jacob Masters, Troy, KS (US); David Alan Leiszler, Clifton, KS (US)

(72) Inventors: Austin Anthony Schmitz, Axtell, KS (US); Peter Jacob Masters, Troy, KS (US); David Alan Leiszler, Clifton, KS (US)

(21) Appl. No.: 15/652,530

(22) Filed: Jul. 18, 2017

Related U.S. Application Data
(60) Provisional application No. 62/363,693, filed on Jul. 18, 2016.

(51) Int. Cl. B65B 69/00; A01D 87/12

(52) U.S. Cl. CPC B65B 69/0033; A01D 87/127

(57) ABSTRACT

A system and method for removing material wrapped around a hay bale is provided. The system may comprise first and second generally opposing arms, a cutting device, and a grabbing device. The first and second arms are adapted for receiving a bale therebetween. One or both of the arms may be pivotably movable or linearly movable in order to receive and be positioned proximate a side of a bale. The cutting device may be movably coupled to the first arm and adapted for selectively traveling between first and second ends (e.g., a proximal end and a distal end) of the first arm. The grabbing device may be movably coupled to the second arm and adapted for selectively traveling between first and second ends (e.g., a proximal end and a distal end) of the second arm.

### CROSS-REFERENCE TO RELATED APPLICATIONS

This application claims the benefit of U.S. Provisional Patent Application No. 62/363,693, filed Jul. 18, 2017, the entire disclosure of which is hereby incorporated by reference.

### FIELD OF THE INVENTION

The present invention generally relates to an apparatus and method for cutting, grabbing, and removing net wrap and other wrapping materials from large round bales of forage material by mechanical methods. The invention is compatible with bale forks (spears) for skid steers, tractors, or other equipment used to deliver bales to livestock.

### BACKGROUND

The invention of plastic net wrap allowed hay producers to wrap large round bales of hay in a shorter amount of time and reduce the amount of hay lost to spoilage. Net wrap is typically comprised of woven plastic that packages a bale. Previously, producers had wrapped bales in sisal twine that could rot away allowing spoilage. Plastic net wrap does not degrade or decompose in the environment and can quickly clutter feeding facilities if not removed. The trash that is left in feeding facilities can become wrapped up in manure spreaders, yard mowers, and field tillage equipment or blown through the countryside. If consumed, net wrap can block the intestinal tract and/or decrease the stomach capacity of livestock because it does not decompose or break down.

Removing net wrap from large round hay bales can be a strenuous and potentially dangerous activity for livestock producers. This is a multi-step process with several physically demanding steps. To complete the process, an operator must dismount from the machine used for transporting the hay, cut the net wrap, remove the net wrap from the bale, collect the net wrap, and then remount the machine to finish feeding the bale. Feeding hay bales weighing, for example ˜1100 pounds, near livestock also exposes producers to potentially dangerous situations. Livestock often crowd around the tractor when a bale is delivered to the feedlot and the operator has to move through the cattle to perform the task of removing net wrap. Adverse weather conditions can also make it stressful to remove net wrap as livestock must be fed daily, in rain, cold, or heat.

To assist producers with the removal of net wrap many different designs have been developed to aid the process. One such known machine is an apparatus for cutting twine from around a bale detailed in U.S. Pat. No. 6,263,774, granted on Jul. 24, 2001 to Jerome S. Rogness. The machine in U.S. Pat. No. 6,263,774 cuts twine or net wrap while the bale is held by the grapple and bucket of a loader. However, currently no known implement exists for cutting and removing the net wrap while leaving the bale intact.

Another design that utilizes a bucket and grapple to assist in the removal of net wrap is described in Canadian Patent No. 2,273,306, granted on Nov. 28, 2000 to Allen Schwitzer. With this remover, a drum with tines is used to engage and collect net wrap upon itself. After the twine is wound about the drum two hydraulic cylinders are actuated to engage a cutterbar that cuts the twine off while the drum rotates. A limitation of this design is that the net wrap is not removed from the device with every bale and is not compatible with bale forks.

Accordingly, a need exists for a system that cuts and removes net wrap from a bale while leaving the bale intact. Another need exists for a system that is compatible with bale forks (spears) and allows the bale forks to operate in their original embodiment without interference. Such a system would allow livestock producers to use a bale forks (spears) to haul hay from fields to barns to feeding locations without having to change implements.

### SUMMARY OF THE INVENTION

One embodiment of the present invention is generally directed to a system and method for removing material wrapped around a hay bale. The system may comprise first and second generally opposing arms, a cutting device, and a grabbing device. The first and second arms are adapted for receiving a bale therebetween. The cutting device may be movably coupled to the first arm and adapted for selectively traveling between first and second ends (e.g., a proximal end and a distal end) of the first arm. The grabbing device may be movably coupled to the second arm and adapted for selectively traveling between first and second ends (e.g., a proximal end and a distal end) of the second arm.

Another embodiment of the present invention is generally directed to a net wrap removal implement. The implement may be configured for attachment to a tractor, skid steer, telehandler, pickup, truck, pull-type wagon, or other vehicle or piece of equipment. In one embodiment, the implement may include a bale forks frame with net wrap remover affixed to it; a net wrap remover consisting of one or more swing arms and cross beam; swing arms that hinge upon a pin mounted to the cross beam; at least one hydraulic cylinder to actuate one or more of the swing arms; a cutting mechanism mounted upon a swing arm of the remover; a grabbing mechanism mounted upon a swing arm of the remover; motors (e.g., an electric motors, hydraulic motors, or the like) or other powered means to power the cutting and grabbing mechanisms along the swing arm; and a serrated knife or blade affixed to the cutting mechanism. The implement may further include a roller chain, cable, belt or the like to convert motor rotational motion to linear motion of the cutting and grabbing mechanisms; hooks mounted upon the grabbing mechanism; and an actuator (e.g., hydraulic cylinder, electric linear actuator, rotary actuator, or the like) to open and close the hooks of the grabbing mechanism.

The swing may be folded for transport. The swing arms can also be folded closed during the moving of bales wherein the cutting of net wrap is not desired. The means to fold in and out the swing arms may include a rack and pinion. It will be appreciated that, in one embodiment, a single hydraulic cylinder may actuates both swing arms. The grabbing mechanism may be fixed or movable, and multiple grabbing mechanisms can be employed in some embodiments. In one embodiment, the cutter is located on the left side and the grabber is located on the right side. In other embodiments, the cutter is located on the right side and the grabber is located on the left side. The cutting and grabbing mechanisms can be mounted on respective trolleys that movably carry the cutting and grabbing mechanisms down the length of the respective arms.

Other and further objects of the invention, together with the features of novelty appurtenant thereto, will appear in the course of the following description.

### BRIEF DESCRIPTION OF THE SEVERAL VIEWS OF THE DRAWING

The features of the invention can be better understood with reference to the following drawings and the detailed description of the preferred embodiment. Emphasis of the drawings is placed on illustrating the principles of the embodiment and not necessarily the scale. In the drawings, reference numbers designate equivalent parts throughout several drawings and views.

FIG. 1 is an isometric view of the mechanical net wrap remover with arms prepared for engaging bale according to one embodiment of the present invention;

FIG. 2 is an isometric view of the mechanical net wrap remover folded for transport or folded for engaging bales that do not yet need the net wrap removed according to one embodiment of the present invention;

FIG. 3 is a top view of the mechanical net wrap remover with cutter and grabbing mechanism extended to distal end of arms according to one embodiment of the present invention;

FIG. 4 is a top view of the mechanical net wrap remover with cutter and grabbing mechanism retracted to base end of arms according to one embodiment of the present invention;

FIG. 5 is a front right isometric view of the skid steer and mechanical net wrap remover preparing to load a bale according to one embodiment of the present invention.;

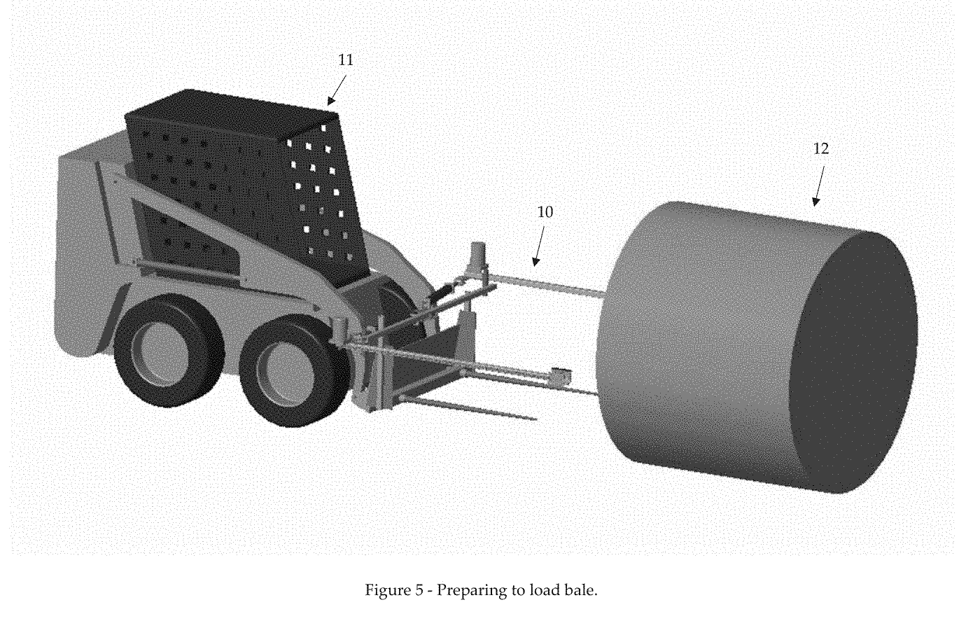

FIG. 6 is a left side view of the skid steer and mechanical net wrap remover with a loaded bale according to one embodiment of the present invention;

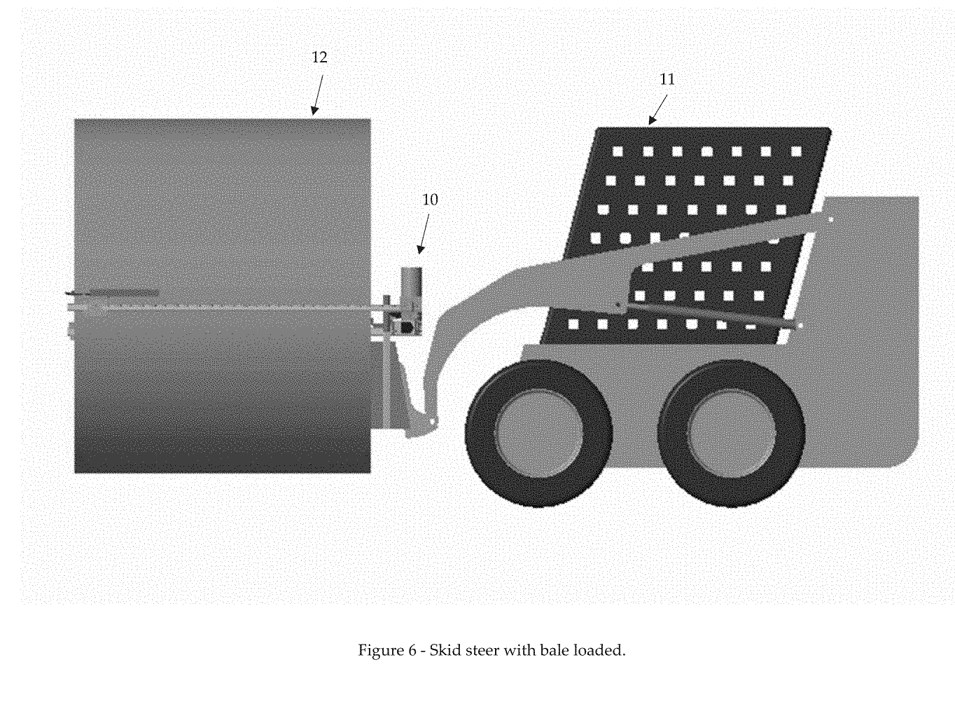

FIG. 7 is a top view of the skid steer and mechanical net wrap remover preparing to load a bale according to one embodiment of the present invention;

FIG. 8 is a top view of the skid steer and mechanical net wrap remover with the bale loaded and preparing to engage mechanical net wrap removal arms according to one embodiment of the present invention;

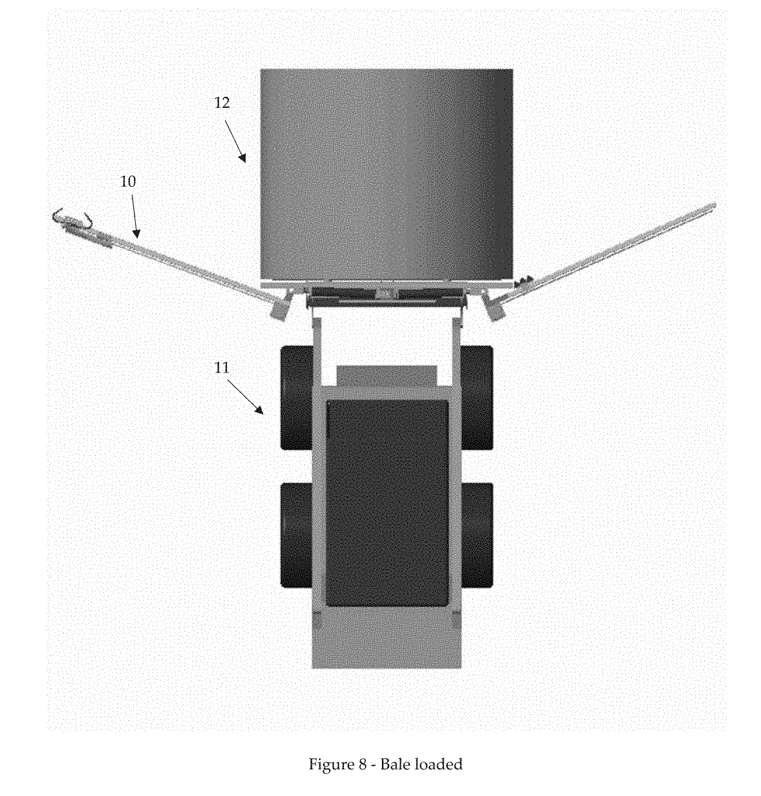

FIG. 9 is a top view of the skid steer and mechanical net wrap remover after the arms have been engaged with bale according to one embodiment of the present invention;

FIG. 10 is a top view of the skid steer and mechanical net wrap remover after the arms have opened to pull off the net wrap according to one embodiment of the present invention;

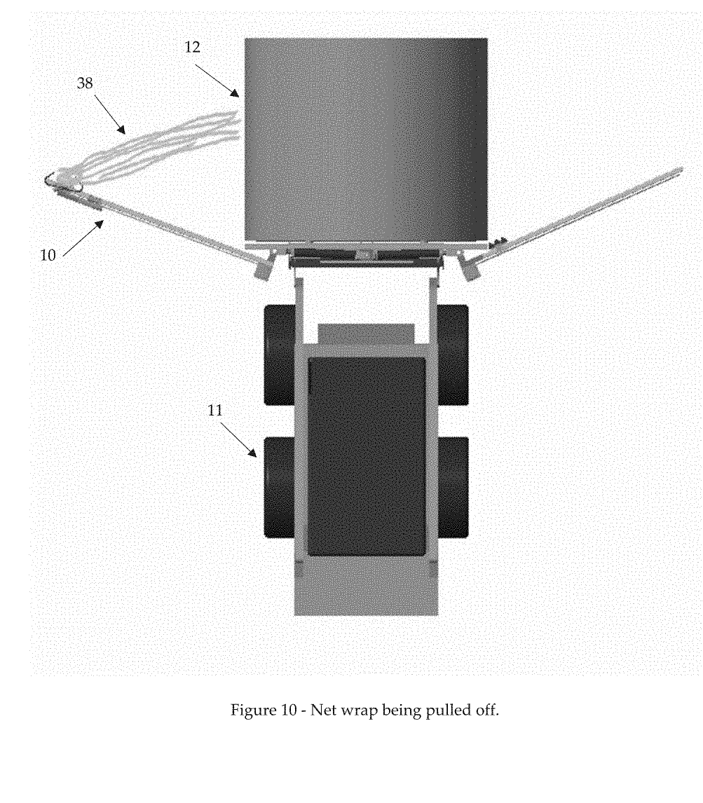

FIG. 11 is an isometric view of the trolley that carries the cutting and grabbing mechanisms upon the swing arms according to one embodiment of the present invention;

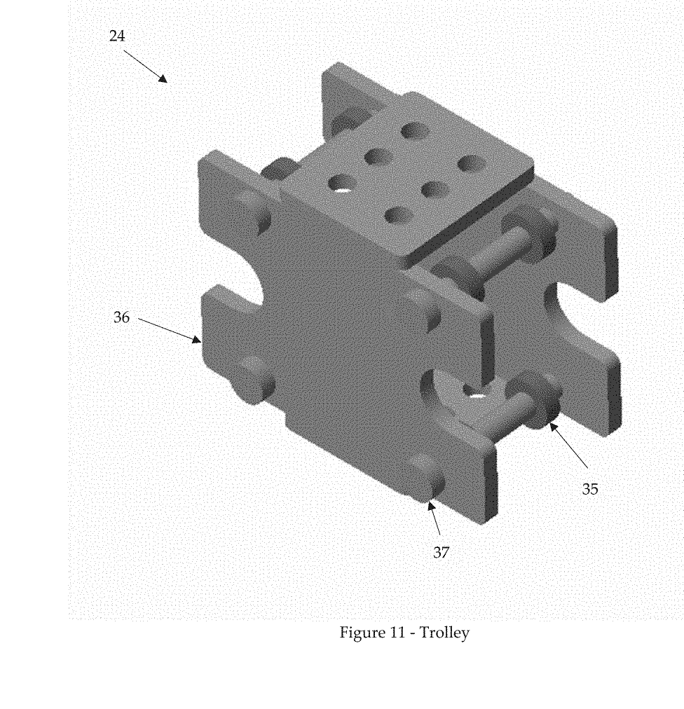

FIG. 12 is an isometric view of the grabbing mechanism in the open configuration according to one embodiment of the present invention;

FIG. 13 is an isometric view of the grabbing mechanism in the closed configuration according to one embodiment of the present invention; and

FIG. 14 is a flow chart illustrating an overview of a method of using the mechanical net wrap remover according to one embodiment of the present invention.

### DETAILED DESCRIPTION OF THE PREFERRED EMBODIMENT

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

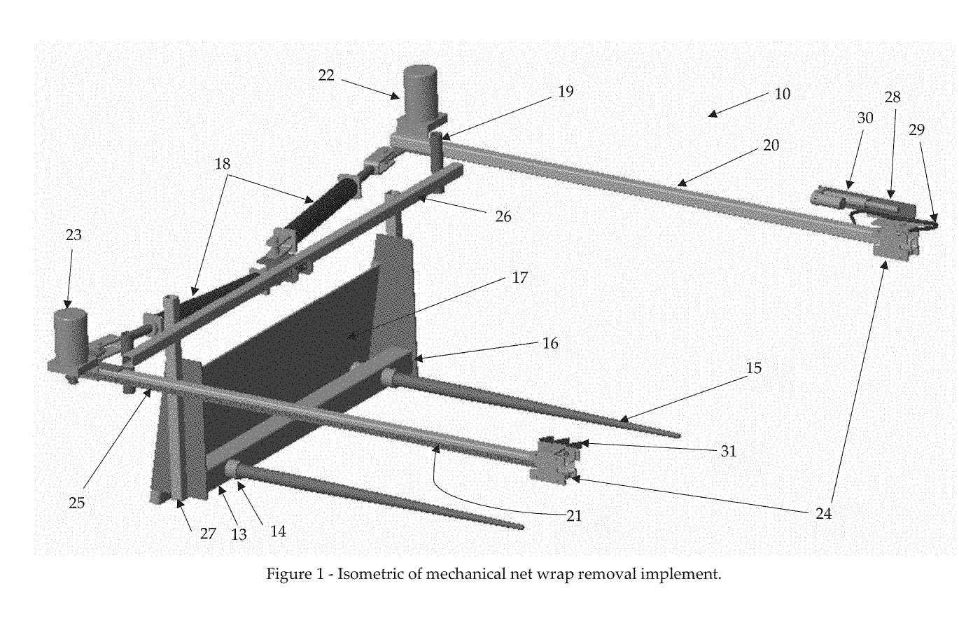

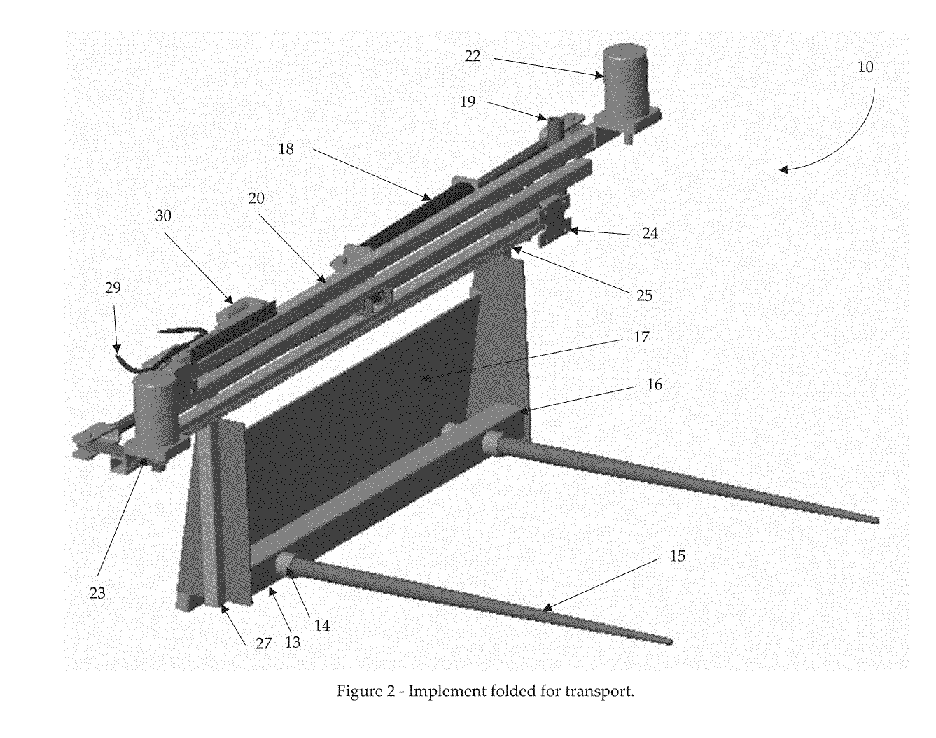

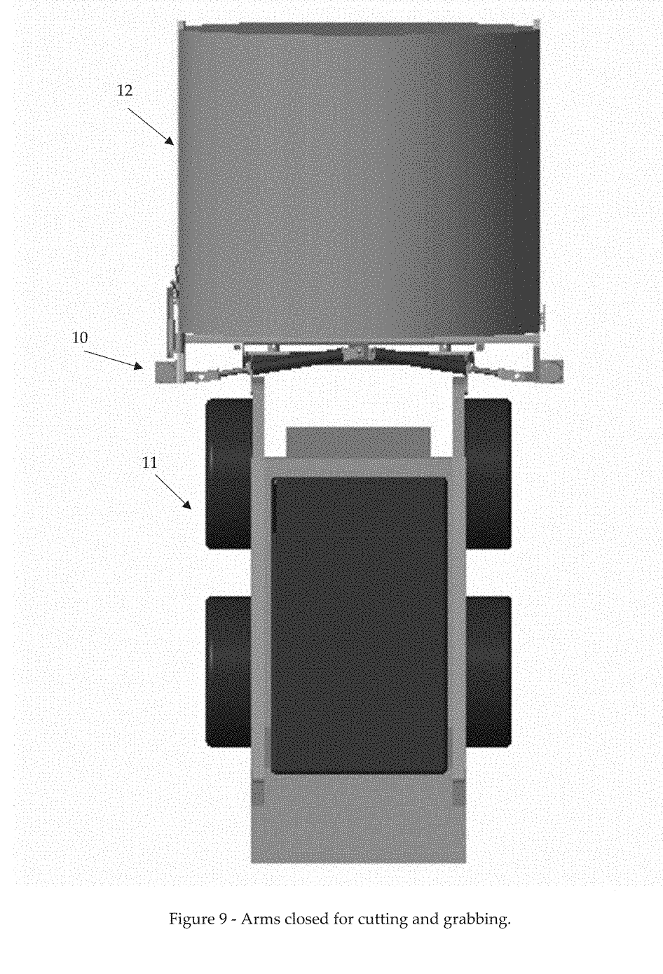

Referring to FIG. 1 and FIG. 2, the mechanical net wrap remover according to one embodiment of the present invention can be seen. References made to certain directions (e.g., right, left, front, and rear) are determined when viewed from the operator station of tractor or skid steer 11 when the implement is mounted to the front loader linkage, as best shown in FIG. 9. The remover 10 may be mounted to a tractor, skid steer 11, or other suitable equipment by means of a quick attach plate 17. The frame 16 can consist of quick attach plate 17, square tubing 13, and round tubing 14 where spears 15 are secured. The quick attach plate 17 or frame 16 may further include couplers or other means of attachment by which the quick attach plate 17 or frame 16 may be coupled, pinned or otherwise attached to a tractor, skid steer 11, or other equipment.

As shown, the remover 10 has a right swing arm 21 that carries the cutter 31 and a left swing arm 20 that carries the grabbing mechanism 28. Alternatively, it will be appreciated that the grabbing mechanism 28 may be carried on the right swing arm 21 and the cutter 31 may be carried on the left swing arm 20. The cutter 31 and grabbing mechanism 28 can be mounted on respective trolleys 24 that movably carry the cutter 31 and grabbing mechanism 28 down the length of the arms 20, 21. In one embodiment, the trolleys 24 are moved by chains 25 that are powered by electric motors 22, 23 mounted upon the arms 20, 21. However, it will be appreciated that the trolleys 24 may be propelled by other means now known or hereafter developed. For example, in other embodiments, the trolleys 24 may be moved by gears, belts, cables, screw drives, rack and pinion assemblies, motors mounted to the trolleys 24, or combinations thereof.

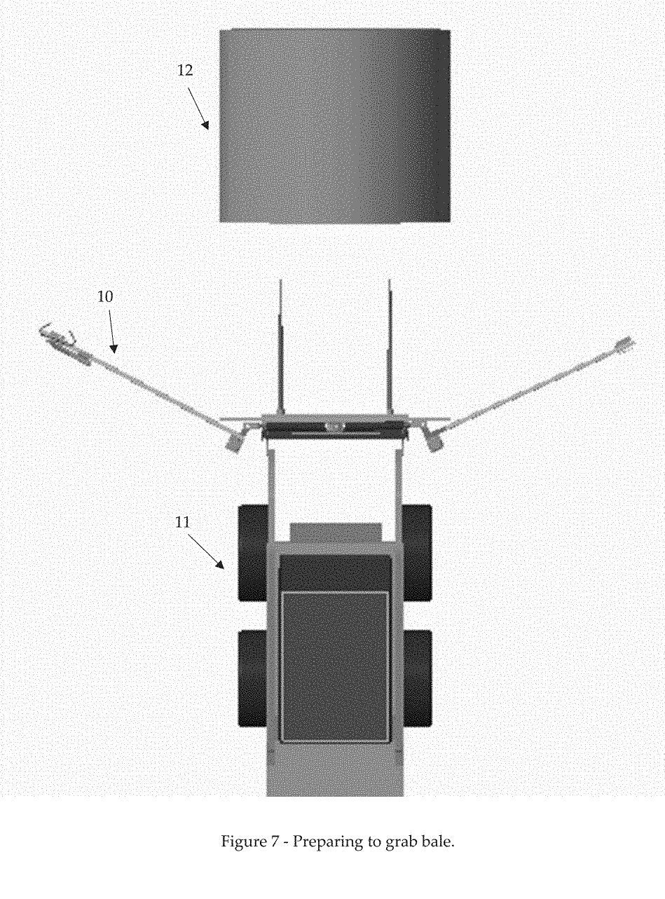

As shown, the arms 20, 21 are pivotally coupled to the cross beam 26. The arms 20, 21 can be folded in and out under the power of hydraulic cylinders 18 about the hinges 19. The arms 20, 21 can be seen in a folded-up position for transport in FIG. 2, the arms 20, 21 can be seen in an open position in FIG. 7, and the arms 20, 21 can be seen in a generally parallel or opposing open position in FIG. 2. It will be appreciated that the arms 20, 21 can be folded and unfolded by other means now known or hereafter developed. For example, in other embodiments, the arms 20, 21 can be folded and unfolded by linear actuators, motors or servomotors.

With the arms 20, 21 in the fully folded position shown in FIG. 2, bales 12 can be hauled from one location to another, for example from field to shed, from field to outdoor storage location, and from shed or outdoor storage, without unmounting of the remover 10.

The trolley 24 may consist of four steel plates 36 welded together with roller bearings 35 bolted above and below the swing arms 20, 21 allowing the trolley 24 to roll back and forth along its respective arm 20, 21 when pulled upon by the chain 25. The trolley 24 can alternatively be made without wheels as just a sleeve around the swing arm 20, 21. The trolley 24 could also feature polyblock to reduce friction between the sleeve and the swing arm 20, 21. Other suitable mechanisms for coupling and guiding the trolley 24 relative to its respective arm 20, 21 are also within the scope of the present invention.

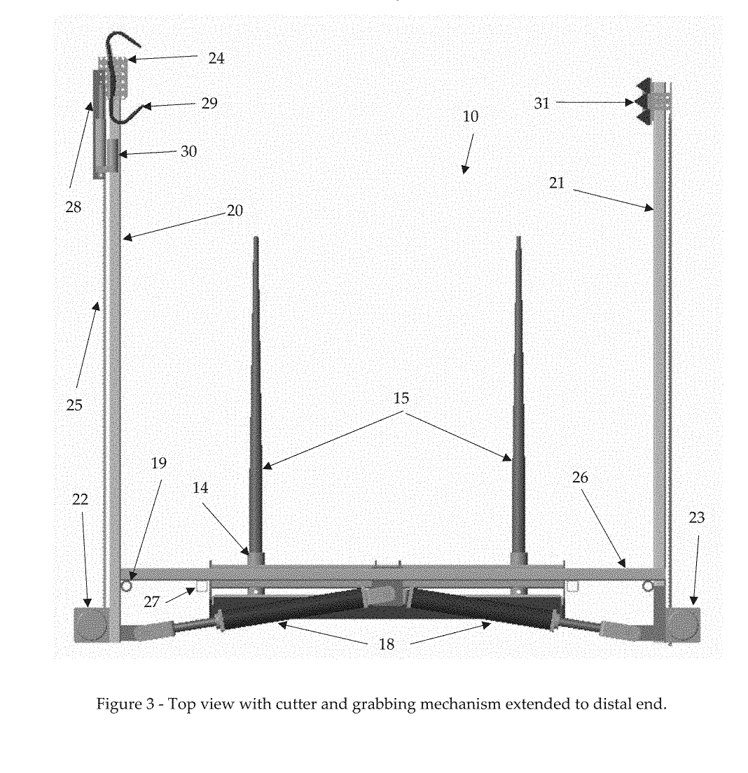

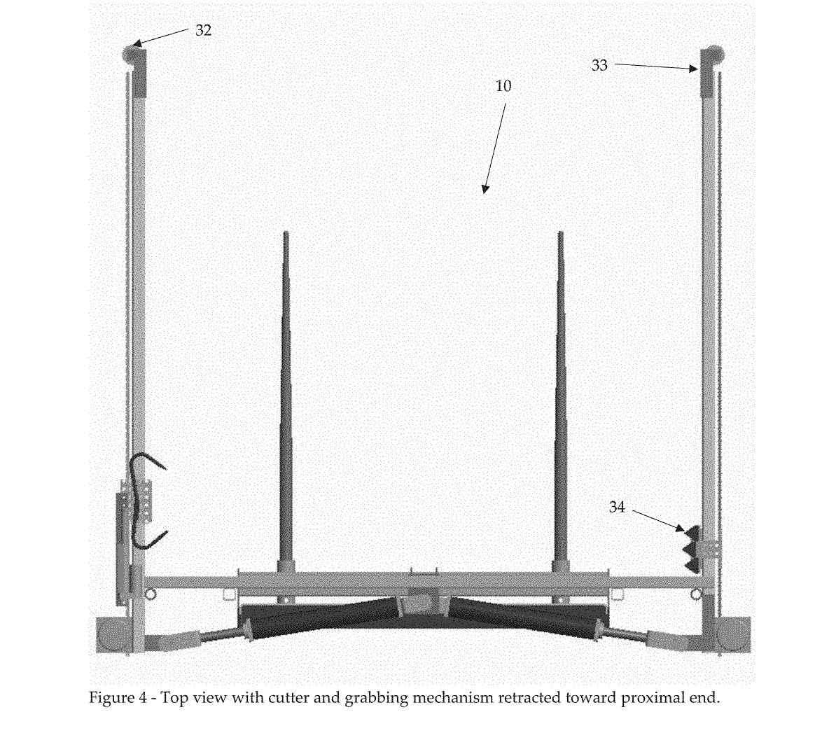

As illustrated in the figures, the trolley 24 may be fixed to the chain 25 and given linear motion along the swing arms 20, 21 by the chain 25 which is powered by a respective motor 22, 23. As schematically shown in FIG. 4, the chain 25 goes around an idler sprocket 32 at the distal end of the swing arm 20, 21. The idler sprocket 32 may be fixed in place by a bracket 33. In FIG. 3 and FIG. 4, the trolleys 24 can be seen extended to distal end and retracted to the proximal end, respectively. For the cutter 31, the chain 25 runs on the right (outside) of the swing arm 21 where it is fixed to the trolley 24. After the chain 25 goes around the idler sprocket 32 it returns on the inside of the square tubing that makes up the swing arm 21. The same design occurs for the grabber 28 on the left swing arm, however the chain 25 runs on the left (outside) of the left swing arm 20. The chain 25 converts the rotational motion of the motor 22, 23 to linear motion along the swing arm 20, 21. An alternative embodiment for the chain 25 could be steel cable to convert the rotational motion to linear motion.

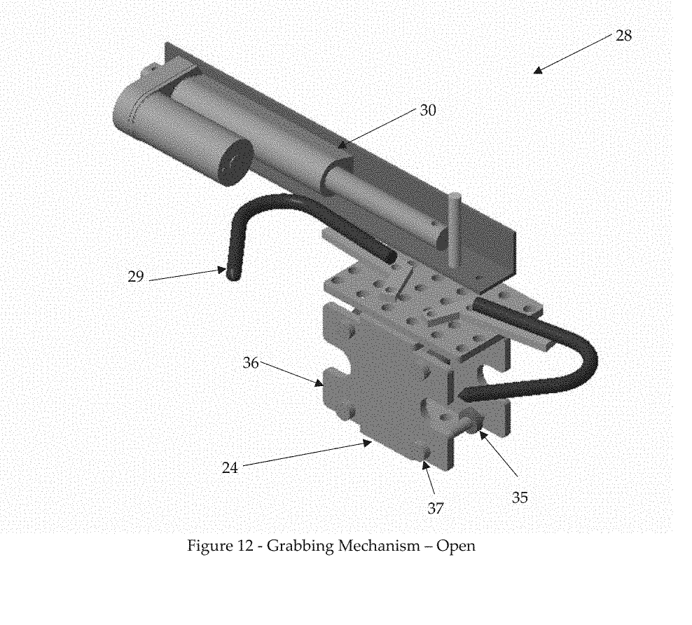

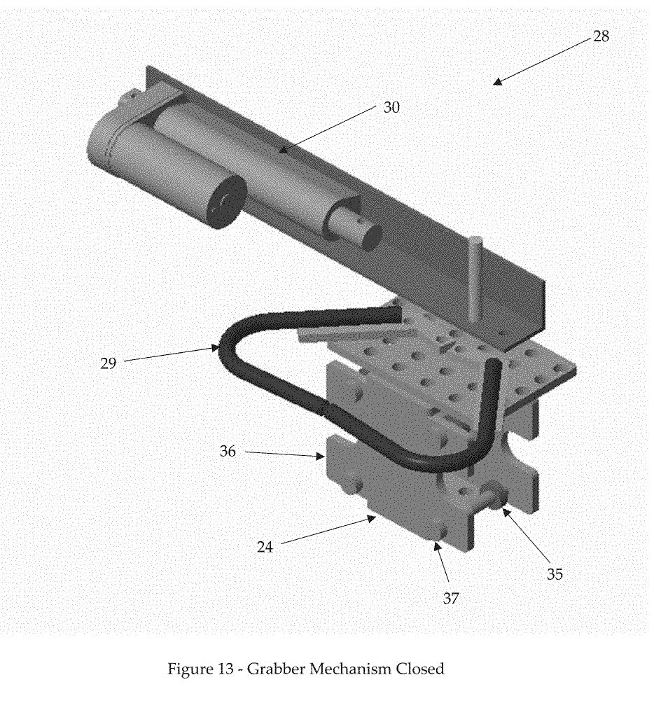

The cutter 31 can consist of sickle sections 34 or other knives, blades or cutting mechanisms which are easily sourced and replaced. The sickle sections 34 can be removably mounted to the trolley weldment 24. In FIG. 12 and FIG. 13, the grabber mechanism 28 can be seen. The grabber mechanism 28 is mounted upon the trolley 24 in its open configuration in FIG. 12. The grabber 28 can consist of hooks 29, projections, grapples, or other structure suitable for engaging the net wrap 38 upon the bale 12. The hooks 29 can be closed by a linear actuator 30 which is retracted in FIG. 13. The linkage of the hooks 29 closes them together like tongs to engage the net wrap 38. Springs (not shown) may be attached to the hooks to assist in the opening and/or closing actions. Alternatively, it will be appreciated that other suitable means for selectively opening and closing the hooks 29 relative to one another may be employed.

An alternative embodiment for the folding in and out of the swing arms 20, 21 is a rack and pinion. The pinion may be fixed/welded to the swing arm 20 and the rack can be held so that it engages the pinion. The pinion may be given linear motion by a hydraulic cylinder 18 that is fixed parallel over the cross beam 26 of the remover 10. With this design, one cylinder 18 could fold in and out both swing arms 20, 21 with a linkage that goes parallel to the cross beam 26 connecting a left and right rack and pinions.

The side supports 27 can be bolted, welded, or otherwise removably or permanently attached to the frame 16 of the forks. The side supports 27 can be selectively moved up and down relative to the frame 16 to provide a way to raise or lower the cross beam 26 to a desirable height where the swing arms 20, 21 are in position to engage the bale 12.

It will be appreciated that the remover 10 may be manufactured and distributed as an entire unit or, alternatively, that certain of its individual components may form a kit adapted for retrofitting existing equipment.

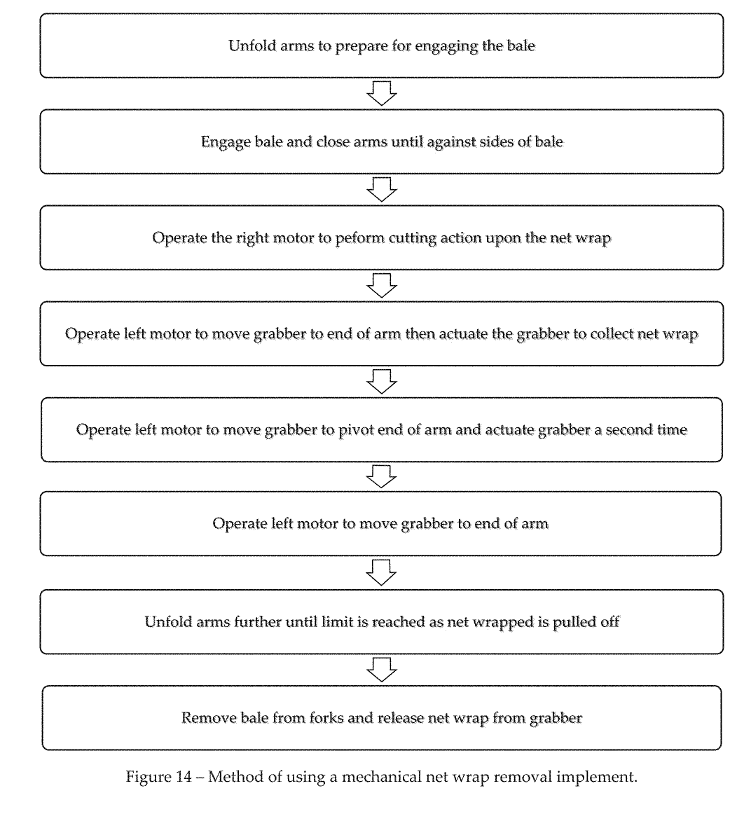

FIG. 14 demonstrates a method of using the remover 10 in accordance with one embodiment of the present invention. As shown, the method can comprise the following steps:

(1) unfolding the arms 20, 21 to prepare for engaging a bale 12,

(2) engaging the bale 12 and closing the arms 20, 21 until against sides of the bale 12,

(3) operating the motor 23 associated with the cutter 31 to perform a cutting action upon the net wrap 38 surrounding the bale 12,

(4) operating the motor 22 associated with the grabber 28 to move the grabber 28 to the distal end of arm 20 (if not already there) and then actuating the grabber 28 to collect the net wrap 38,

(5) operating the motor 22 associated with the grabber 28 to move the grabber 28 to the proximal end (pivot end) of the arm 20 and the actuating the grabber 28 a second time,

(6) operating the motor 22 associated with the grabber 28 to move the grabber 28 back to the distal end of arm 20,

(7) unfolding the arms 20, 21 further until limit is reached as the net wrap 38 is pulled off of the bale 12, and

(8) removing the bale 12 from the forks 15 and releasing the net wrap 38 from the grabber 28.

The initiation of the foregoing steps may be manually controlled or, alternatively, some or all of the steps may be automated though use of an electronic controller or computer system.

Notwithstanding the recitation of the foregoing steps, it will be understood that the cutting step may occur when the cutter 31 is traveling either from the distal end to the proximal end of the arm 21, or from the proximal end to the distal end of the arm 21. Similarly, it will be understood that the step of grabbing the net wrap may occur when the grabber 28 is traveling either from the distal end to the proximal end of the arm 20, or from the proximal end to the distal end of the arm 20.

While the bale 12 illustrated in the figures is a large round bale, it will be appreciated that the remover 10 described herein may be adapted for use with bales of various sizes, shapes and configurations. Additionally, while net wrap 38 material is discussed herein and shown in the figures, the remover 10 of the present invention can be adapted for removing various types of material from bales including, but not limited to, net wrap, plastic sheet wrapping, film, twine and other materials surrounding the bales.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions and methods described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A system for removing material wrapped around a bale, the system comprising:
first and second generally opposing arms adapted for receiving a bale therebetween;
a cutting device movably coupled to the first arm, wherein the cutting device is adapted for selectively traveling between first and second ends of the first arm; and
a grabbing device movably coupled to the second arm, wherein the grabbing device is adapted for selectively traveling between first and second ends of the second arm.

2. A net wrap removal implement of the features defined below comprising:
a bale forks frame with net wrap remover affixed to it;
a net wrap remover consisting of swing arms and cross beam;
swing arms that hinge upon a pin mounted to cross beam;
at least one hydraulic cylinder to actuate swing arms;
a cutting mechanism mounted upon the swing arm of the remover;
a grabbing mechanism mounted upon the swing arm of the remover;
motors to power the cutting and grabbing mechanisms along the swing arm;
a roller chain to convert motor rotational motion to linear motion of the cutting and grabbing mechanisms;
a serrated knife or blade affixed to the cutting mechanism;
hooks mounted upon the grabbing mechanism; and
a linear actuator to open and close the hooks of the grabbing mechanism;
wherein the swing arms can be folded for transport;
wherein the swing arms can be folded closed during the moving of bales that cutting of net wrap is not desired.

3. The net wrap removal implement of claim 2, wherein the motors are electric motors or hydraulic motors.

4. The net wrap removal implement of claim 2, wherein one hydraulic cylinder actuates both swing arms.

5. The net wrap removal implement of claim 2, wherein the linear actuator comprises a hydraulic cylinder.

6. The net wrap removal implement of claim 2, wherein the linear actuator comprises an electric linear actuator.

7. The net wrap removal implement of claim 2, wherein a means to fold in and out the swing arms is a rack and pinion.

8. The net wrap removal implement of claim 2, wherein the linear actuator comprises a rotary actuator.

9. The net wrap removal implement of claim 2, wherein the grabbing mechanism may be fixed.

10. The net wrap removal implement of claim 9, wherein multiple grabbing mechanisms are used.

11. The net wrap removal implement of claim 2, wherein the cutter is located on the left side.

12. The net wrap removal implement of claim 2, wherein the grabber is located on the right side.

13. The net wrap removal implement of claim 2, wherein the cutting mechanism and grabbing mechanism are each mounted to a respective trolley, and the trolleys are movable by a cable.
